(19) United States
(12) Patent Application Publication
(10) Pub. No.: US 2007/0265899 A1
(43) Pub. Date: Nov. 15, 2007

(54) METHOD, SYSTEM AND STORAGE MEDIUM FOR TRANSLATING STRATEGIC CAPABILITIES INTO SOLUTION DEVELOPMENT INITIATIVES

(75) Inventors: Robert C. Angier, Raleigh, NC (US); David T. Angley, Brewster, NY (US); David D. Argust, Kingston, NY (US); Charles G. Catledge, Marietta, GA (US); Linda L. Scheib, Austin, TX (US); Carol J. Singer, Hastings-on-Hudson, NY (US); Elizabeth C. Szymanowicz, Newburgh, NY (US)

Correspondence Address: CANTOR COLBURN LLP - IBM FISHKILL, 55 GRIFFIN ROAD SOUTH, BLOOMFIELD, CT, 06002, US

(73) Assignee: International Business Machines Corporation, Armonk, NY (US)

(21) Appl. No.: 11/382,788

(22) Filed: May 11, 2006

(51) Int. Cl. G05B 19/418

(52) U.S. Cl. 705/8

(57) ABSTRACT

A method for translating a defined business strategy into solution development initiatives includes receiving strategic input information related to the defined business strategy. Business and processes requirements are refined in accordance with the strategic input information so as to determine process capability gaps, IT and data gaps, and organization and management system gaps. Any determined process requirements, IT and data requirements, and organization and management system requirements are evaluated so as to identify changes to be implemented to enable corresponding solutions for delivering desired capabilities therein. A solution implementation and deployment approach is outlined, based on the identified changes, and a business case and key results metrics is developed from the outlined solution implementation and deployment approach, with the solution development initiatives being implemented in accordance therewith.

### BACKGROUND

The present invention relates generally to business transformation processes and systems, and, more particularly, to a method, system and storage medium for translating defined strategic capabilities into solution development initiatives.

Business “transformation” has become a popular concept for optimization of operations in order to achieve efficiencies and improved results. Most activities in this area have primarily focused on the Information Technology (IT) changes needed to bring about the desired transformation. In this regard, known tools such as business cases are used to assess the impact of the proposed transformation. However, many transformations have not resulted in the overall improvements or the transformation that was originally envisioned.

There are several methods and approaches available to develop business strategies and plans. There are also many ways to manage projects, monitor projects and operations. The current art makes use of business cases and project planning techniques. Reengineering also focuses on development of “to be” processes based on current “as is” processes in order to achieve more optimal operations. Typically, the result is a focus on IT projects to achieve improved results. However, many times the results expected (and upon which the business case was based) are not achieved.

As businesses move from strategic planning to investment decisions and the implementation of projects, the linkage to strategic intent becomes increasingly distant and difficult to maintain. With current “pain points” demanding attention, many businesses commit to numerous, often disconnected projects that address point issues, rather than strategic transformation itself. This has several potentially disastrous results, including, for example, the investment of resources in the wrong areas, the investment of resources in projects that do not complement one another (and that may actually work against each other), the lack of attention to project interdependencies, the tendency to focus only on IT development and deployment without corresponding attention to other transformation requirements, overlooking key factors for success, such as organizational or process issues, and insufficient metrics to measure results.

In other instances, a businesses may come to an agreement as to specific strategic transformation goals, but may not know how or where to start, with so many options possible. Time and resources are thus wasted by “going in circles.” Moreover, investment decisions may be reached in a “one off” way, culminating in many of the same adverse consequences mentioned above. In either case, the culminating result cases is the investment of millions of dollars in IT, process, and organization changes that are insufficiently integrated to produce the expected results.

Accordingly, it would be desirable to be able to provide a method of implementing comprehensive linkage between strategic planning and project execution in a manner that encompasses the components of process, information technology, data, organization and management system capabilities required to achieve the desired results. Moreover, the methodology would desirably be applicable to organizational entities such as for-profit enterprises, non-profit organizations, academic institutions, and all levels of governmental agencies that need to plan for strategic actions by translating strategy into solution development initiatives.

### SUMMARY

The foregoing discussed drawbacks and deficiencies of the prior art are overcome or alleviated by a method for translating a defined business strategy into solution development initiatives. In an exemplary embodiment, the method includes receiving strategic input information related to the defined business strategy. Business and processes requirements are refined in accordance with the strategic input information so as to determine one or more of process capability gaps, information technology (IT) and data gaps, and organization and management system gaps. One or more of the process requirements, IT and data requirements, and organization and management system requirements are evaluated so as to identify changes to be implemented to enable corresponding solutions for delivering desired capabilities therein. A solution implementation and deployment approach is outlined, based on the identified changes, and a business case and key results metrics is developed from the outlined solution implementation and deployment approach, with the solution development initiatives being implemented in accordance therewith.

In an alternative embodiment, a system for translating a defined business strategy into solution development initiatives includes a host server executing an information engine, the host server connected to a network accessible by one or more client applications. The information engine is configured to implement a method including receiving, through the one or more client applications, strategic input information from a strategic planning process, the strategic input information including parameters related to the defined business strategy. Business and processes requirements are refined in accordance with the strategic input information so as to determine one or more of process capability gaps, information technology (IT) and data gaps, and organization and management system gaps. One or more of the process requirements, IT and data requirements, and organization and management system requirements are evaluated so as to identify changes to be implemented to enable corresponding solutions for delivering desired capabilities therein. A solution implementation and deployment approach is outlined, based on the identified changes, and a business case and key results metrics is developed from the outlined solution implementation and deployment approach, with the solution development initiatives being implemented in accordance therewith.

In still another embodiment, a storage medium includes a machine readable computer program code for translating a defined business strategy into solution development initiatives, and instructions for causing a computer to implement a method. The method further includes receiving strategic input information related to the defined business strategy. Business and processes requirements are refined in accordance with the strategic input information so as to determine one or more of process capability gaps, information technology (IT) and data gaps, and organization and management system gaps. One or more of the process requirements, IT and data requirements, and organization and management system requirements are evaluated so as to identify changes to be implemented to enable corresponding solutions for delivering desired capabilities therein. A solution implementation and deployment approach is outlined, based on the identified changes, and a business case and key results metrics is developed from the outlined solution implementation and deployment approach, with the solution development initiatives being implemented in accordance therewith.

### BRIEF DESCRIPTION OF THE DRAWINGS

Referring to the exemplary drawings wherein like elements are numbered alike in the several Figures:

FIG. 1 is a high-level block diagram illustrating the role of an Initiative Definition Process (IDP) with regard to translating identified strategic capabilities into solution development initiatives, in accordance with an embodiment of the invention;

FIG. 2(a) is a more detailed block diagram illustrating the sequence of the process activities implemented in the IDP of FIG. 1;

FIG. 2(b) is a more detailed representation of the various inputs and outputs of the process activities within the IDP shown in FIG. 2(a);

FIG. 3 is a diagram illustrating the system architecture in an exemplary embodiment; a network system 300 suitable for implementing the initiative definition method is now described; and

FIGS. 4A through 4C depict partial views of a detailed flow diagram of the various subroutines included within the IDP methodology, in accordance with a further embodiment of the invention.

### DETAILED DESCRIPTION

Disclosed herein is method, system and storage medium for translating identified strategic capabilities into solution development initiatives through a process referred to herein as “initiative definition.” Initiative definition encompasses the components of process, information technology, data, organization and management system capabilities required to achieve the desired results, whether in for-profit enterprises, non-profit organizations, academic institutions, or governmental agencies that need to plan for strategic actions by translating strategy into solution development initiatives.

More specifically, the initiative definition process disclosed herein is part of a larger portfolio management process that includes both strategic planning and solution development processes. The initiative definition process ensures that a business or organization transformation undertaken is in alignment with a comprehensive strategic plan and includes evaluations not only of IT requirements, but also the process(es) being transformed, the data impacts, and the organization and management system changes that will be required. Without exploring all these aspects as part of an initiative definition process, a business transformation is at a great risk of not achieving the desired results. The process described hereinafter is scaleable from a business unit all the way to an enterprise level, and may be integrated within the enterprise to tie the results together into a holistic set of results.

Various terminologies referred to in the following description are provided and defined below for purposes of convenience and clarity:

As used herein, the term “business” applies broadly to any entity, including for-profit enterprises, non-profit organizations, academic institutions, and all levels of governmental agencies that need to plan for strategic actions by translating strategy into solution development initiatives.

“Business process” refers to any high-level process that is defined by the business and applies to all aspects of the business.

“Business rules” govern how various processes operate.

“Capability gaps” are those in a current operation, and which must be closed to achieve the required process and strategic capabilities. For each process capability, gaps are determined by examining the current process design and operation, noting the differences between the current design and operation and the required capability.

“Data capability gap” is a gap in the ability of the current data system(s) and/or structure(s) to provide the capability required to enable the strategic capabilities included in the initiative definition.

In this context, a “dependency” is defined as any process operation outside of the scope of the initiative that is required to enable processes within the initiative.

“Executive sponsor” refers to a person who champions an initiative, holds the funding and resources or has ample authority to influence funding and resources, and makes the decision whether to proceed at key points during the initiative definition.

“Information technology capability gap” is a gap in the ability of the current technology system(s) and/or architecture to provide the capability required to enable the strategic capabilities included in the initiative definition.

An “initiative” is a group of related solutions and assets which, when developed and deployed, has a transformational effect on the business. Initiatives may spawn multiple solutions. Generally, it includes major IT development, process development or change, and organization and management system change.

“Management system capability gap” is a gap in the ability of the current management system(s) to provide the capability required to enable the strategic capabilities included in the initiative definition.

“Organization capability gap” is a gap in the ability of the current organization system and structure(s) to provide the capability required to enable the strategic capabilities included in the initiative definition.

“Process capability” is the capability a process must provide in order to achieve a strategic capability. A useful way to define a process capability is to fill in “y” in the following sentence: In order to enable strategic capability “x,” the process must be able to “y.”

“Process capability gap” is a gap in the ability of the current process(s) to provide the capability required to enable the strategic capabilities included in the initiative definition.

“Process components” describe how the process will operate to enable the desired process capabilities.

“Scenarios” provide a real-life context into which the abstract process capabilities are exercised to ensure they support the required strategic capabilities.

A “solution” is a development project or program that may either impact business transformation or provide a tactical solution. The workflow of a solution provides the controls needed for a transformation. The solution can include other solutions or assets, or can just stand alone.

A “stakeholder” is a person, group of persons or organization(s) that have a vested interest in the investment required and outcome desired from the initiative.

“Strategic capability” is a high-level capability that a business requires in order to achieve its strategy.

“Strategic intent” is defined by the strategy of a business and states the desired outcome of the strategy.

“Unit” is any defined group within a business. Typically, a unit has some autonomy and authority to make decisions for its group, in order to accomplish its specific objectives.

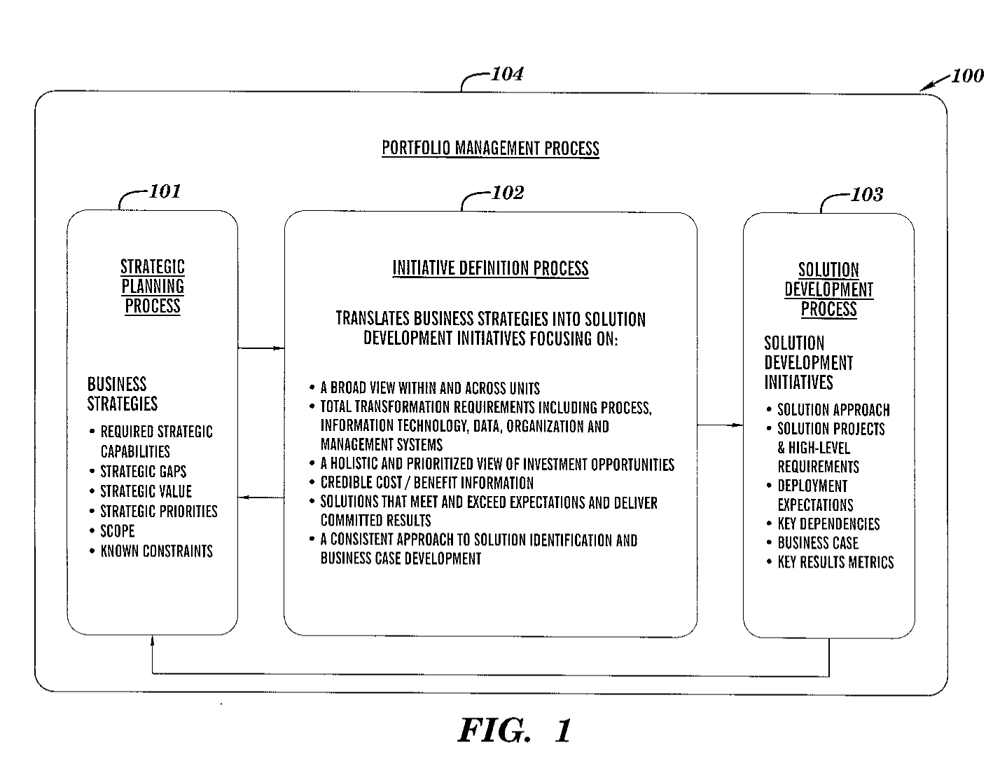

Referring initially to FIG. 1, there is shown a high-level block diagram 100 illustrating the role of the Initiative Definition Process with regard to other key planning and development processes, in accordance with an embodiment of the invention. In particular, a Strategic Planning Process 101 (though which the business identifies required strategic capabilities, strategic gaps, strategic value, strategic priorities, scope and known constraints) provides inputs to the Initiative Definition Process (IDP) 102. The IDP 102 in turn translates the inputs from the Strategic Planning Process 101 are translated into Solution Development Initiatives 103. As described in further detail herein, the IDP 102 provides outputs representative of a complete and holistic view of transformation requirements, impacts, prioritized investment opportunities, cost/benefit information, and solutions defined to deliver against expectations, all with a consistent approach to solution identification and business case development.

The IDP 102 provides these outputs to the Solution Development Process 103, which further defines specific projects, deployment expectations and key dependencies for solution development and refines business case and key results metrics. In this process, specific projects are defined and deployed to enable the strategic capabilities and fill capability gaps identified during the IDP 102. The IDP 102 also provides feedback to the Strategic Planning Process 101, communicating which strategic capabilities and priorities are planned to be addressed and which are not.

Once the Solution Development Process 103 is complete, it provides feedback to the Strategic Planning Process 101, identifying which capabilities have been enabled and which gaps have been filled by the projects. Surrounding each of these processes is a Portfolio Management Process 104, which represents the overall management system for determining and managing investment priorities. The Portfolio Management Process 104 constantly monitors changes in strategic direction and modifies initiative development and investments, as required.

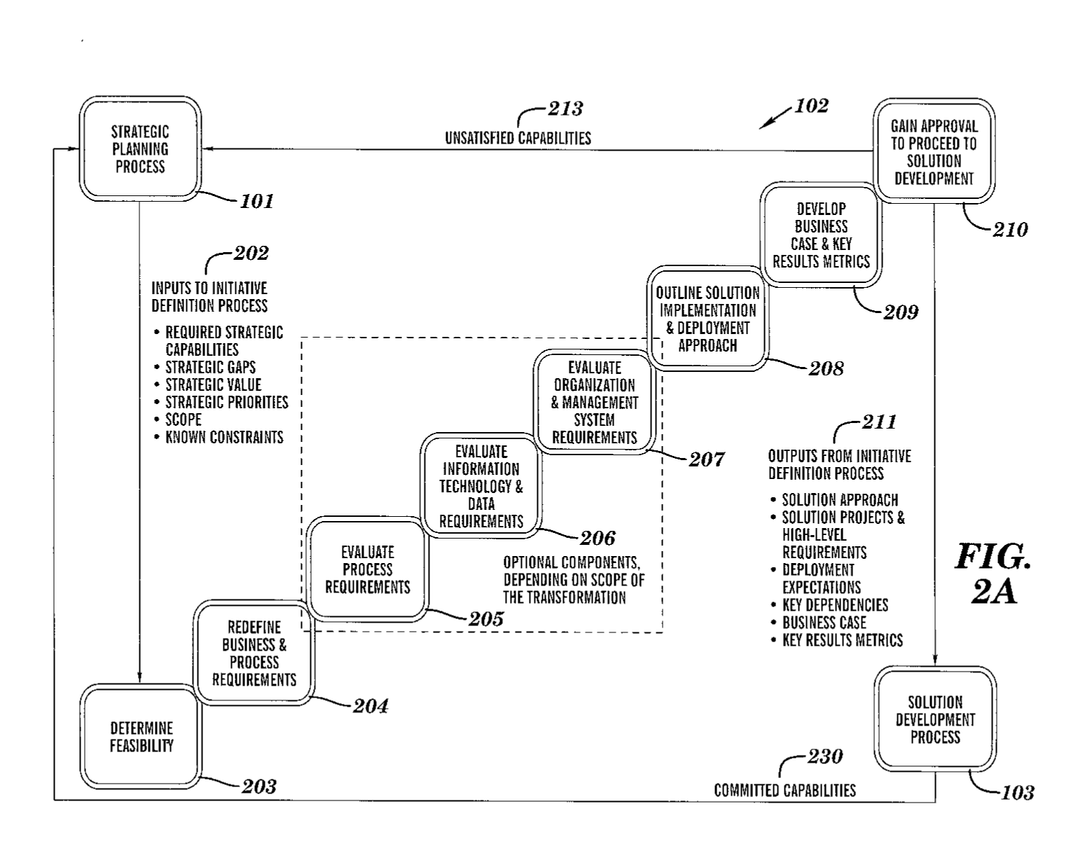

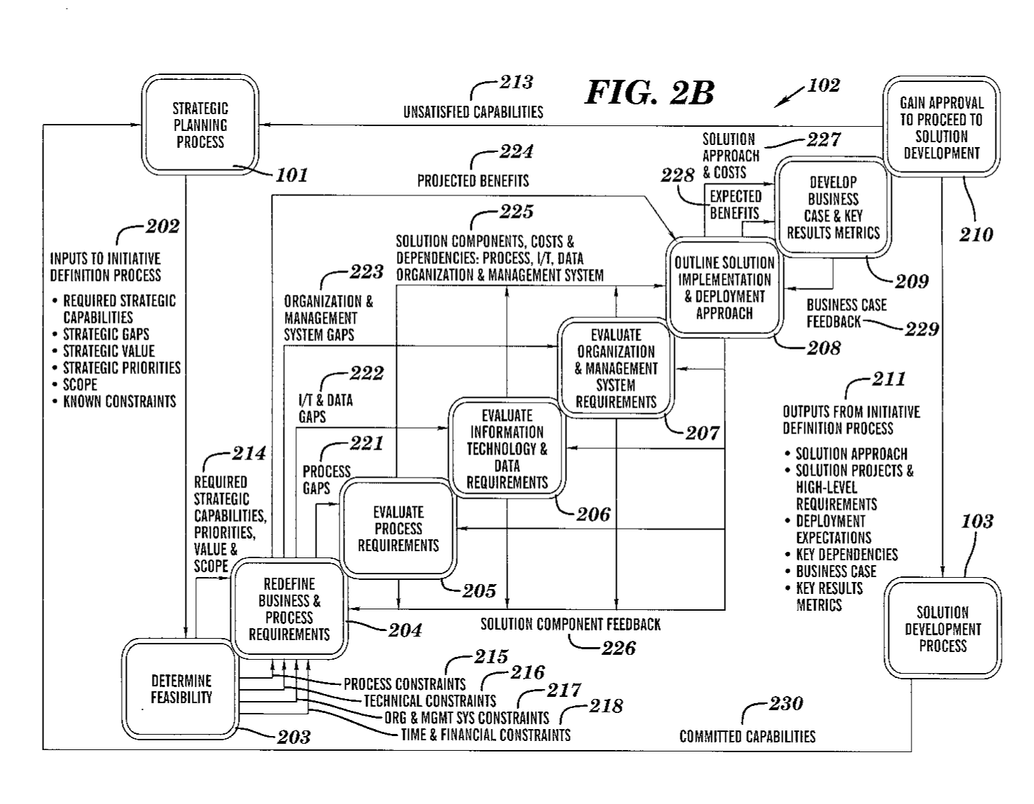

FIG. 2(a) is a more detailed block diagram illustrating the sequence of the process activities implemented in the IDP 102 of FIG. 1, represented as subprocesses 203 through 210 in FIG. 2(a). Depending upon the scope of the transformation, certain of the “evaluation” subprocesses (205, 206, and 207) may or may not be acted upon. FIG. 2(a) further depicts the closed-loop nature of the IDP 102 with respect to the Strategic Planning Process 101, including inputs 202 and outputs 213. This tight affiliation between the Strategic Planning Process 101 and the IDP 102 ensures that ongoing strategic linkage is maintained. In addition, FIG. 2(a) depicts the closed-loop nature of the IDP 102 with respect to the Solution Development Process 103, including outputs 211. The IDP 102 provides guidance to the Solution Development Process 212, ensuring that strategic value is enabled. Finally, to complete the closed loop, outputs 230 of committed capabilities from the Solution Development Process 103 are provided as feedback to the Strategic Planning Process 101. This enables the communication for continuous status of committed capabilities to flow into the Strategic Planning Process 101.

FIG. 2(b) is a more detailed representation of the various inputs and outputs of the subprocesses within the IDP 102 shown in FIG. 2(a). The process activities are highly interactive, thus ensuring appropriate linkage and completeness. Each subprocess builds logically from the previous one(s), and, where necessary, feedback loops internal to the Initiative Definition Process 102 provide data for corrective action or modifications to ensure the holistic and complete nature of the transformation. Each of the subprocess activities and deliverables are described in detail in following paragraphs.

System Architecture

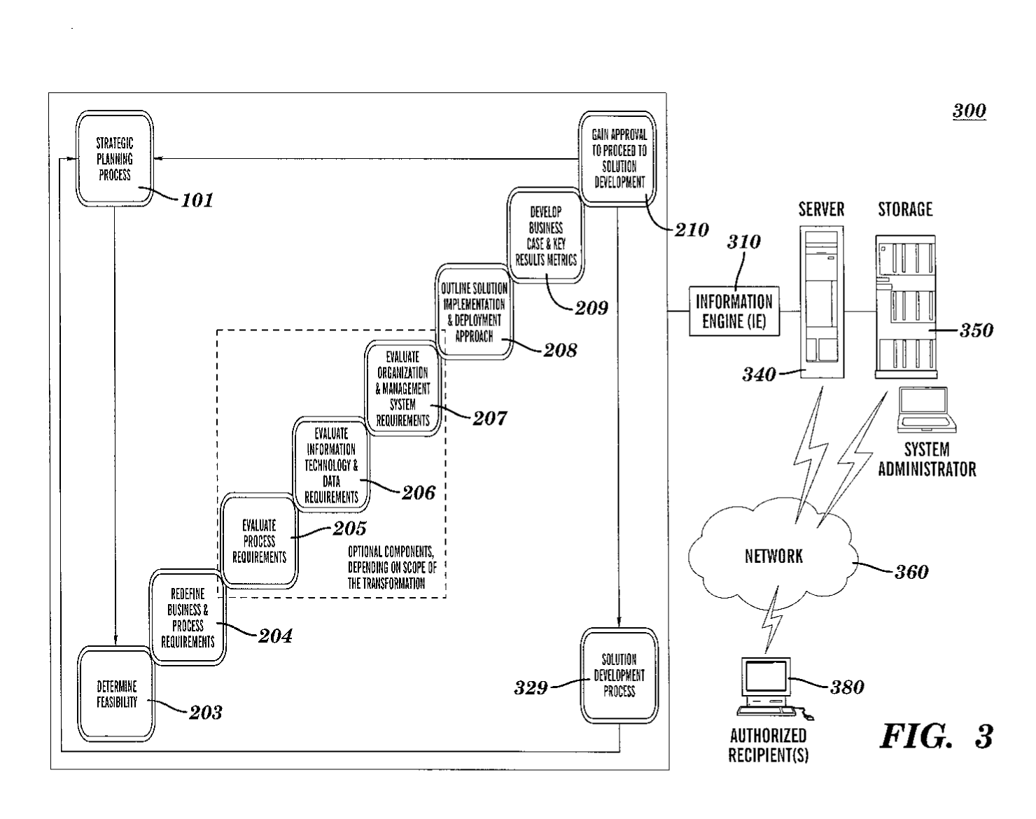

Referring now to both FIG. 2(b) and FIG. 3, a network system 300 suitable for implementing the initiative definition method is now described. System 300 includes a host system or server 340 executing an information engine 310. The information engine 310 integrates the different components of the system, including the Strategic Planning Process 101, the Determine Feasibility subprocess 203, the Refine Business and Process Requirements subprocess 204, the optional Evaluate Process Requirements subprocess 205, the optional Evaluate Information Technology and Data Requirements subprocess 206, the optional Evaluate Organization and Management System Requirements subprocess 207, the Outline Solution Implementation and Deployment Approach subprocess 208, the Develop Business Case and Key Results Metrics subprocess 209, the Gain Approval to Proceed to Solution Development subprocess 210, and the Solution Development Process 103. Those skilled in the art will appreciate that the implementation of the invention embodiments will vary in the actual processes and subprocess used, depending on the scope, objectives and intended use.

As indicated above, the Strategic Planning Process 101 sets strategic direction and priorities for the enterprise and identifies possible strategic initiatives.

The Determine Feasibility subprocess 203 examines the feasibility of moving forward with a strategic initiative. In so doing, it considers the strategic capabilities 214 required in view of known constraints 215, 216, 217, 218, identifies feasible options to overcome the constraints and identifies persons and/or organizations that are stakeholders in the initiative. This is documented in such a way that the sponsor can decide whether to proceed with initiative definition. If the decision is to proceed, then the Refine Business and Process Requirements component 204 is invoked. The documentation is stored in storage system 350 and may be accessed by authorized recipients 380 via the network 360. In lieu of being a separate subprocess apart from the Strategic Planning Process 101, the Determine Feasibility subprocess 203 could optionally be integrated therein.

The Refine Business and Process Requirements subprocess 204 uses the documentation of the Determine Feasibility subprocess 203 and translates strategic capabilities into process capabilities and considers unit-specific requirements and options to overcome requirement conflicts. This is documented in such a way that the sponsor can decide whether to proceed with initiative definition. If agreement to proceed is reached, this component results in defined process capabilities, identified capability gaps that must be closed to achieve the strategic intent of the initiative, and business and transformational benefits of closing the gaps. This documentation is also stored in storage system 350 and serves as input to the Evaluate Process Requirements subprocess 205 and may be accessed by authorized recipients 380 via the network 360.

The Evaluate Process Requirements subprocess 205 focuses on evaluating the process changes required to enable a solution that delivers the desired process capabilities. Process gaps 221 are identified, requirements for initiative-unique rules are identified, the high-level process components are designed and dependencies identified, and costs are estimated to implement the process components. This documentation is stored in storage system 350 for use later in the Outline Solution Implementation and Deployment Approach subprocess 208. Any or all parts of the documentation may also be accessed via the network 360 by authorized recipients 380, as required, to ensure consistency with other process components.

The Evaluate Information Technology and Data Requirements subprocess 206 evaluates the information technology (IT) and data requirements 222 of the initiative, evaluates current IT and data architectures versus initiative requirements, and results in a high-level IT systems and data component design including dependencies and estimated implementation costs. This documentation is stored in storage system 350 for use later in Outline Solution Implementation and Deployment Approach subprocess 208. Any or all parts of the documentation may also be accessed via the network 360 by authorized recipients 380, as required, to ensure consistency with other process components.

The Evaluate Organization and Management System Requirements subprocess 207 evaluates the organization and management system requirements 223 of the initiative and results in a high-level organization and management system design, including dependencies, an assessment of the business' ability and willing to change, and estimated implementation costs. This documentation is stored in Storage system 350 for use later in Outline Solution Implementation and Deployment Approach subprocess 208. Any or all parts of the documentation may also be accessed via the network 360 by authorized recipients 380, as required, to ensure consistency with other process components.

The Outline Solution Implementation and Deployment Approach subprocess 208 outlines the implementation of the solution and how it will be deployed. It also considers projected benefits 224 alternatives, identifies assumptions, dependencies and risks (225), and results in a solution approach 227 with expected benefits 228 and projects defined and a deployment timeline. This is documented in such a way that the sponsor can decide whether he/she agrees with the recommended solution and agrees to proceed with initiative definition. If the decision is to proceed, then Develop Business Case and Key Results Metrics subprocess 208 is invoked. The documentation is stored in storage system 350 and may be accessed by authorized recipients 380 via the network 360.

The Develop Business Case and Key Results Metrics subprocess 209 focuses on evaluating the cost to implement the solution and the short-term and long-term benefits of enabling the desired process capabilities over a specific time horizon and results in a high-level cost/benefit analysis and key results metrics. Business case feedback 229 may be provided to the Outline Solution Implementation and Deployment Approach subprocess 208. This is documented in such a way that the sponsor can decide whether he/she agrees with the business case and agrees to proceed with initiative definition. If the decision is to proceed, then the Gain Approval to Proceed to Solution Development subprocess 210 is invoked. The documentation is stored in storage system 350 and may be accessed by authorized recipients 380 via the network 360.

The Gain Approval to Proceed to Solution Development subprocess 210 focuses on obtaining approval to proceed to solution development and results in needed management approvals to go forward. The template that is created to summarize pertinent information about the initiative (so that the approval body can ascertain the scope, cost and benefit) is stored in storage system 350 and may be accessed by authorized recipients 380 via the network 360. If agreement is reached, the initiative is transferred to the Solution Development process 103, whose team members can access as authorized recipients 380 via the network 360. Unsatisfied capabilities are returned to the Strategic Planning Process component 101 for further consideration in strategic planning cycles. Similar technology capabilities may be used to augment the Strategic Planning Process 101 and Solution Development Process 103.

Server 340 may be connected to a storage system 350 and through a network 360 to client systems 370, 380 or other networks. The server 340 may be implemented using one or more servers operating in response to a computer program stored in a storage medium accessible by the server. The server 340 may operate as a network server (e.g., a web server) to communicate with the client systems 370, 380. Server 340 handles sending and receiving information to and from client systems 370, 380 and can perform associated tasks. Server 340 executes various applications typically found in a business or enterprise.

Server 340 may include an IBM® eServer™ (iSeries™, pSeries™, xSeries™ or zSeries™) or any other suitable commercially-available computer systems depending on the scope of the implementation. The server 340 may execute web server software designed to accommodate various forms of communications typically utilized by large enterprises. Any web server software or similar program that handles general communications protocols and transport layer activities could be used as appropriate for the network protocol in use. For purposes of illustration, the server is running IBM's Lotus Domino™ and Lotus Notes™ as its groupware applications software; however, any compatible e-mail-integrated, web-enabled collaborative software could be used.

Storage system 350 may be implemented using a variety of devices for storing electronic information. It is understood that this device may be implemented using memory contained in the server 340 or it may be a separate physical device. The storage system 350 is logically addressable as a consolidated data source across a distributed environment that includes a network 360.

Information stored in the storage system 350 may be retrieved and manipulated via the server 340. The storage system 350 includes a data repository containing documents, data, web pages, images, multimedia, etc. In an exemplary embodiment, the server 340 operates as a database server and coordinates access to application data including data stored within the storage system 350.

The storage system 350 comprises any form of mass storage device configured to read and write database-type data maintained in a file store (e.g., a magnetic disk data storage device). The storage system can range from a single Hard Disk Drive on a personal computer to a large enterprise storage system, i.e., IBM's Shark™. Of course, it will be appreciated that the storage system may be one that consists of multiple disk subsystems which may be geographically dispersed and coupled via network architecture.

There is no positive requirement that the storage system be maintained in one facility; to the contrary, the volume of information stored therein may dictate geographical dispersion and the like. The storage system 350 is logically addressable as a consolidated data source across a distributed environment such as a network system. The implementation of local and wide-area database management systems to achieve the functionality of the storage system will be readily understood by those skilled in the art. Information stored in the storage system is retrieved and manipulated by a database manager. For purposes of illustration, the database manager may be IBM's DB/2 software. The storage system provides a repository for a library of documents and data that are created and utilized by the process.

Network 360 may be any type of known network including, but not limited to, a Local Area Network (LAN), a Wide Area Network (WAN), a global network (e.g., Internet), a Virtual Private Network (VPN), an intranet, or other network configuration known in the art. These networks may be implemented using a wireless network or physically connected to each other in a state of the art configuration, to include a direct cable. One example of a wireless connection is bluetooth technology. One or more of the client systems 370, 380 may be coupled to the server 340 through multiple networks (e.g., intranet and Internet) so that not all clients systems 370, 380 are coupled to server 340 through the same network. One or more of the client systems 370, 380 and the server 340 may be connected to the network 360 in a wireless fashion. For example, one or more client systems 370, 380 may execute a user interface application (e.g., a web browser) to contact the server 340 through the network 360, while another client system is directly connected to the server 340.

Client systems 370, 380 comprise general purpose computer devices that allow systems to connect to the network and host system. Client systems may access host via seller's web browsers located therein.

In particular, a System Administrator 370 refers to a client system operated to manage the performance, operation, and maintenance of the host system, storage system and networks identified in the foregoing discussion. The System Administrator manages the server 340, storage system 350, and network 360.

An Authorized Recipient 380 is the intended receiver of information. At various times during execution of the invention, authorized recipients may include members of the initiative definition team, sponsor(s), stakeholders, members of the solution development team, members of the strategic planning process team, and/or members of other initiative development teams. The capability to share the data among various participants enhances the collaboration that is required to execute an effective initiative definition. If there is more than one authorized recipient, the System Administrator 370 may establish one or more work groups, depending on the deployment.

Strategic Planning Process and Start Initiative Definition

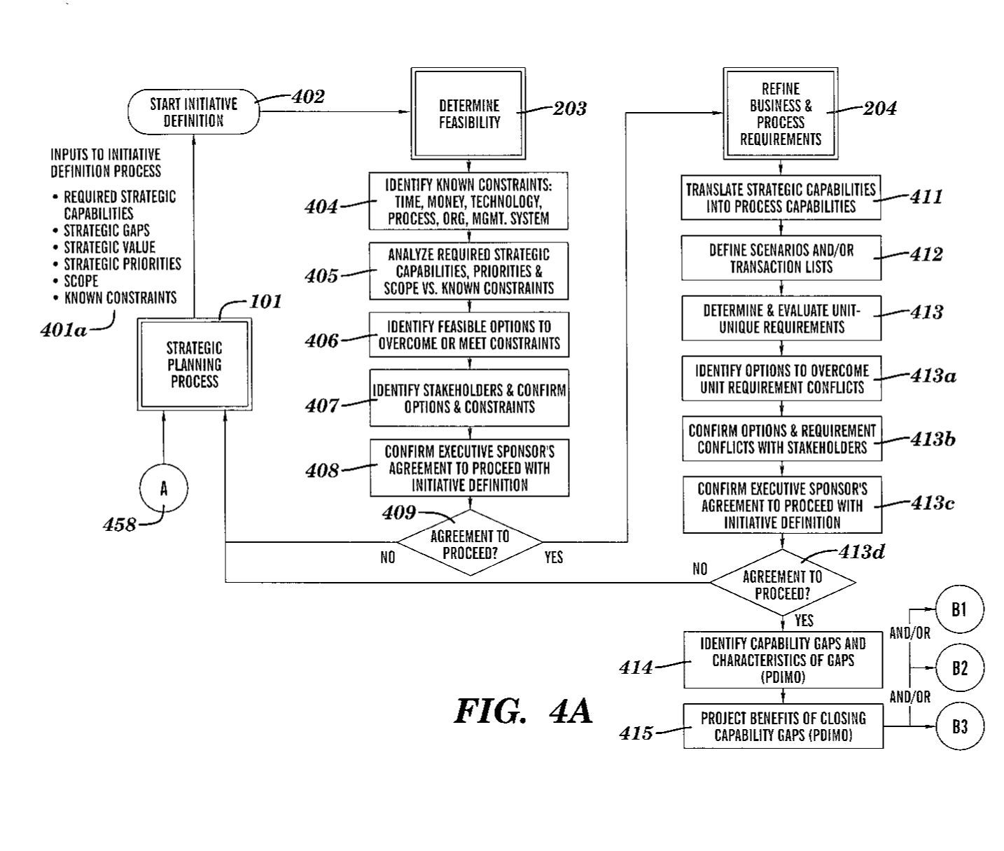

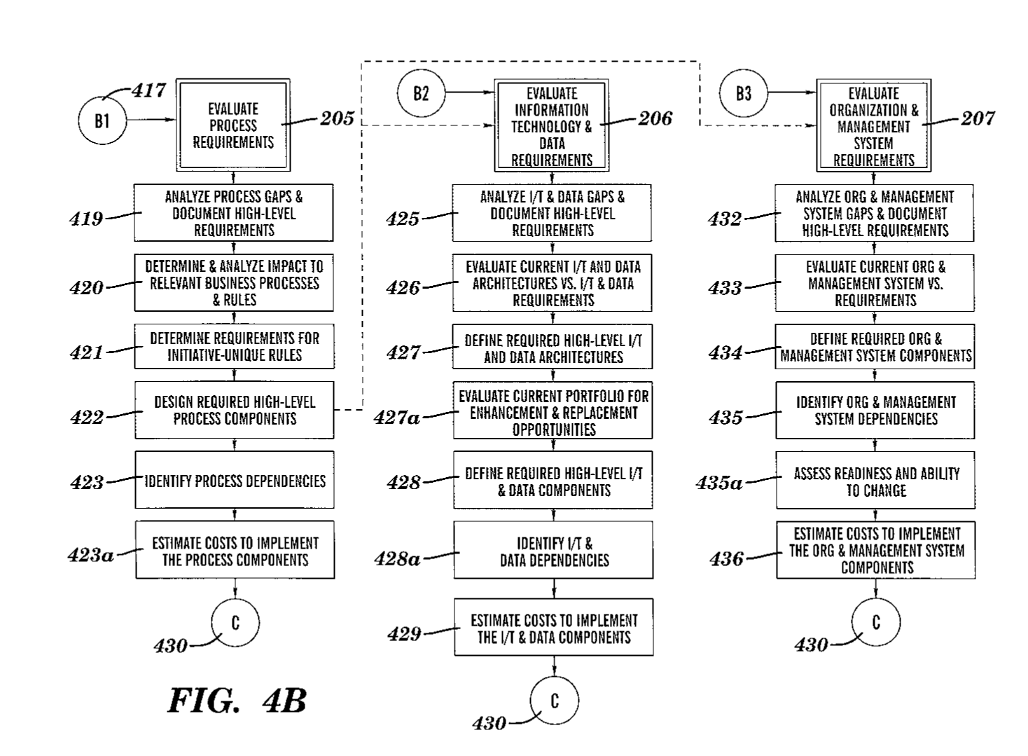

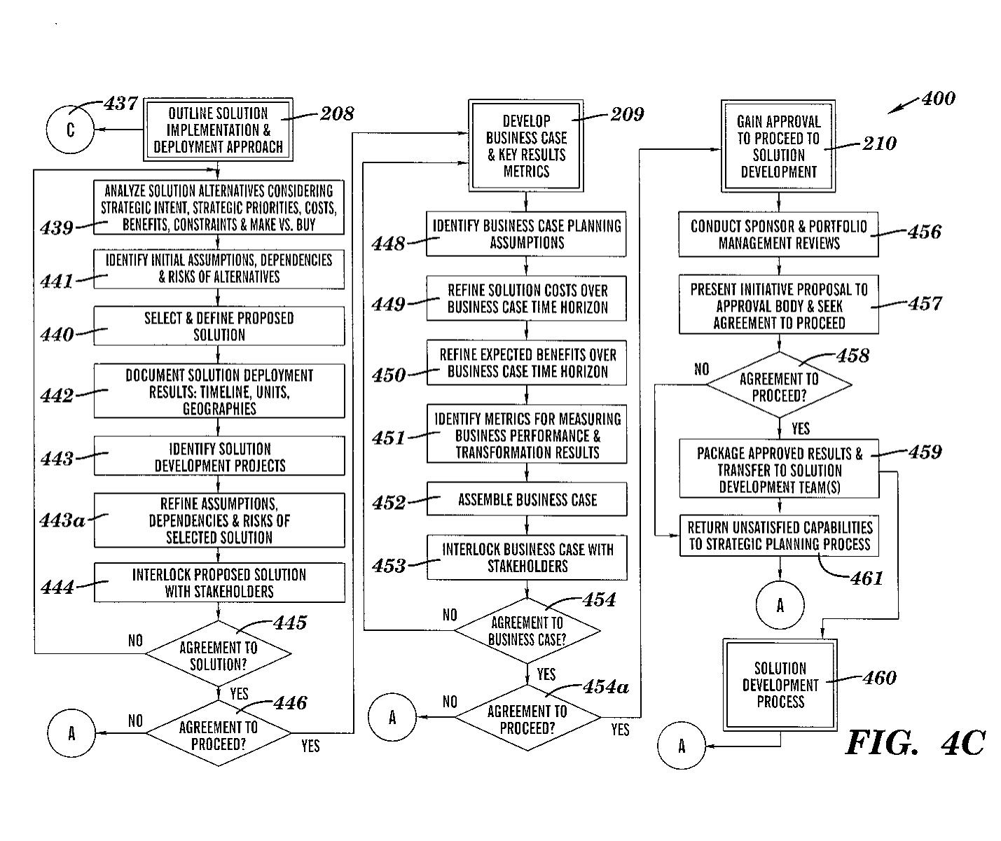

Referring now to FIG. 4A, there is shown a more detailed section of a flow diagram illustrating the relationship between the Strategic Planning Process 101 (though which the business identifies required strategic capabilities, strategic gaps, strategic value, strategic priorities, scope and known constraints) with the start 402 of the Initiative Definition Process 102 outlined above.

Determine Feasibility

As shown in FIG. 4A, the Determine Feasibility subprocess 203 of the present methodology examines the feasibility of proceeding with initiative definition through a sequence of process steps 404-409, the execution of which results in a decision and agreement whether or not to continue the tasks of fully defining the initiative. Making the “go/no go” decision early in the process prevents investment in further activities when known constraints prohibit feasible progress.

In particular, block 404 identifies known constraints that could affect the success of the initiative. Such constraints may include, for instance, time, money, technology, process, data or organizational capability, as well as regulatory or legal requirements and geographic and business practices. For example, the business may require that the initiative be completed and deliver results within 18 months. Similarly, laws and regulations may require specific actions or deliverables that must be adhered to in the transformation initiative.

Block 405 analyzes the inputted strategic capabilities and their priorities, expected value and scope against the known constraints. Here, the constraints are related to the strategic capabilities to examine and quantify effect and impact. For example, a corporate-wide technology platform/application standard may constrain the strategic capability to “Make decisions jointly with suppliers.”

In block 406, options are examined that mitigate and/or function within the known constraints, while delivering the expected value of the strategic capabilities. Options considered unfeasible can be dismissed at this time. Feasible options are defined sufficiently so to enable stakeholders (block 407) and executive sponsor(s) (block 408) to make decisions whether to proceed with the initiative definition (decision block 409). If trade-offs are required or expectations must be reset, those actions are identified at this time.

Considering the feasible options defined in block 406, groups that have a vested interest in the initiative (stakeholders) are identified in block 407. Inherent in this step is the identification of stakeholders across the span of the business (all units and geographies). These stakeholders are then presented with the identified constraints and feasible options. This step ensures that all stakeholders understand and agree to the known constraints and feasible options for proceeding. If stakeholders do not agree with an option, the option is either redefined until it is acceptable or removed as an option.

In block 408, the executive sponsor(s) analyzes the feasible options and stakeholder input to determine whether to proceed with the initiative definition. If known constraints result in compromises that negatively impact the expected value, the sponsor may decide to halt the initiative definition, with feedback to the strategic planning process. The strategic planning process would then reexamine the business' strategic intent. If the options appear credible, the executive sponsor(s) gives the direction to proceed with initiative definition. This decision is made at decision block 409. Alternatively, as stated above, the Determine Feasibility subprocess 203 may optionally be included as part of the Strategic Planning Process 101.

Refine Business and Process Requirements

As further shown in FIG. 4A, refining of business and process requirements 204 is implemented through a sequence of process steps 411-415. These steps result in defined process capabilities and identified capability gaps that are to be closed in order to achieve the strategic intent of the initiative. Furthermore, the business and transformational benefits of closing the gaps are also identified.

Block 411 translates the strategic capabilities defined in the Strategic Planning Process 101 and confirmed in the Determine Feasibility Process subroutine 203 into process capabilities. A useful way to define a process capability is to fill in “y” in the following sentence: In order to enable strategic capability “x”, the process must be able to “y.” A typical strategic capability will decompose into multiple process capabilities, each at a sufficient level of detail to identify a key business process that enables the parent strategic capability. For example, a strategic capability of “Enable Web Sales” might decompose into process capabilities such as “Display Products”, “Display Prices”, “Allow Product Selection”, “Collect Payment Information” and “Collect Shipment Information.”

Block 412 defines scenarios that incorporate the process capabilities derived in block 411. The scenarios provide a real-life context into which the abstract process capabilities are exercised to ensure they support the required strategic capabilities. Further, creating the scenarios serves to flush out additional process capabilities that may have been overlooked in the original decomposition block 411. The scenarios are also used in subprocesses 205, 206, 207 and 208 to ensure that the process, data, information technology, management system and organization components and the proposed solution are able to perform in the manner required to enable the strategic capabilities.

Block 413 determines and evaluates requirements that are unique to a particular unit in a multi-unit business. These requirements may relate to the constraints identified in block 404 or they may be uncovered as the process and strategic capabilities are applied to a particular unit. These requirements are evaluated for conflicts with the required strategic (block 405) and process (block 411) capabilities.

Block 413a defines feasible options that mitigate and/or work within with the unit requirement conflicts (block 413), while delivering the expected value of the strategic capabilities. Options considered unfeasible can be dismissed at this time. On the other hand, feasible options are defined sufficiently to enable stakeholders (block 413b) and executive sponsor(s) (block 413c) to make decisions as to whether to proceed with the initiative definition (decision block 413d). If trade-offs are required or expectations must be reset, those actions are identified at this time.

More specifically, block 413b informs the stakeholders of the unit requirement conflicts and feasible options for proceeding. If stakeholders do not concur with an option, the option is either redefined until it is acceptable or removed as an option. In block 413c, the executive sponsor(s) analyzes the feasible options and stakeholder input to determine whether to proceed with the initiative definition. If unit requirement conflicts result in compromises that negatively impact the expected value, the sponsor may decide to halt the initiative definition, with feedback to the strategic planning process 101. The strategic planning process 101 would then reexamine the business' strategic intent. If the options appear attractive, the executive sponsor(s) gives the direction to proceed with initiative definition, as reflected at decision block 413d.

Using the process capabilities defined in block 411, block 414 then determines the gaps in the current operation that must be closed to achieve the required process and strategic capabilities. For each process capability, gaps are determined by examining the current process design and operation, noting the differences between the current design and operation and the required capability. Multiple gaps may be identified for a single required capability. For example the process capability “Display Price” may require a new Web pricing process, an on-line Web site that does not exist and an automated database of prices that are currently maintained manually. Further, each process capability gap is characterized as one or more of the following: Process, Data, Information Technology, Management System and Organization. In the example described above, the Web pricing process gap would be characterized as “Process,” the on-line Web site gap would be characterized as “Information Technology” and the automated price database gap would be characterized as “Information Technology and Data.” Capability gaps identified in block 414 are subsequently analyzed as described hereinafter.

Block 415 identifies the projected business and transformational benefits that will accrue from closing capability gaps. Benefits are typically expressed in financial terms; however, at this point in initiative definition, they may be expressed in equivalent terms such as productivity gain or market share gain. Non-financial (soft) benefits such as improved customer satisfaction are also identified. Benefits are associated with capability gaps in two ways: 1) a single capability gap closure results in a benefit and 2) multiple capability gap closures are required to achieve a benefit. Benefits identified in this step are used in subprocesses described later.

Referring now to FIG. 4B, in the event that process capability gaps are identified in block 414 of FIG. 4A, then subroutine 205 evaluates the process requirements of the initiative through a sequence of steps 419-423a. These steps result in a high-level process component design, including dependencies and estimated implementation costs. The subroutine 205 focuses on evaluating the process changes required to enable a solution that delivers the desired process capabilities. Subsequent subroutines 206 and 207 evaluate the information technology, data, organization and management system changes required to enable a solution. Further, the results of subroutines 205, 206 and 207 are then integrated (as discussed hereinafter) into an outline of a total solution implementation and deployment approach.

As shown in block 419, the process capability gaps that were identified in block 414 of FIG. 4A are analyzed. This step focuses on gaps that have a process characteristic such as the “Display Price” example cited above, which requires a new process for displaying prices on the web. The requirements for enabling the process changes are identified at a high level and documented. For example, the capability “Display Price” may require new or modified processes that 1) identify the customer, 2) determine if the customer is entitled to a previously contracted price, 3) determine if price discounts are available for quantity purchases, and 4) determine if promotional prices are available.

Block 420 determines whether there are existing business processes or rules that are relevant to the initiative and analyzes the impact that the process requirements identified in block 419 will have on these business processes and rules. In particular, conflicts between the initiative process requirements and business processes and rules are identified. The conflicts are mitigated by modifying the initiative process requirements and/or determining if business processes and rules can be modified without impact to other processes.

Business rules govern how processes operate. Block 421 determines the requirements for business rules that are unique to the initiative. This step focuses on identifying process capabilities that require business rules to operate. For example, the “Display Price” process capability may require business rules to govern which promotional prices are displayed to specific customers or when to add sales tax to the displayed price. The required process capabilities are analyzed and the requirements for business rules are documented. While it is not necessary to formulate the specific business rules at this time, those process capabilities that require business rules to enable them to operate should be identified.

Block 422 uses the results of blocks 419, 420 and 421 to design the required high-level process components of the solution. The process components describe how the process will operate to enable the desired process capabilities. The results may be documented in a process flow diagram with associated content describing the high-level attributes of the process for each step; e.g., input, process operation, output, role or organization executing each step, business rule requirements, and data and/or automation requirements.

Block 423 identifies the dependencies the process components have on other processes external to the initiative. In this context, a dependency is defined as any process operation outside of the scope of the initiative that is required to enable processes within the initiative. For example, the processes that enable “Display Price” may have dependencies on processes outside the initiative that 1) establish customer identification numbers and 2) determine sales tax rates for customers. The identified dependencies are documented in this step and used in a subsequent subprocess to formulate the solution dependencies.

Block 423a estimates the costs to implement the process components of the solution. Exemplary process component costs include 1) end-user training, 2) process operation documentation and 3) ongoing process management. The identified costs are documented in this step and used in a subsequent subprocess to formulate the solution business case.

Where information technology and/or data capability gaps were identified in block 414 of FIG. 4A, then subprocess 206 evaluates the information technology (IT) and data requirements of the initiative through a sequence of steps 425-429. These operations result in a high-level IT systems and data component design, including dependencies and estimated implementation costs. This subprocess focuses on evaluating the IT systems and data changes required to enable a solution that delivers the desired process capabilities identified in subprocess 204, and refined as process components in subroutine 205. Subroutine 207 (also shown in FIG. 4B) evaluates the organization and management system changes required to enable a solution. Further, subprocess 208 (described in FIG. 4C hereinafter) integrates the results of subprocesses 205, 206 and 207 into an outline of a total solution implementation and deployment approach.

Block 425 analyzes the process capabilities and capability gaps that were identified in block 414. This step focuses on gaps that have an IT capability or performance characteristic, such as the “Display Price” example cited above which requires a new IT functions for determining and for displaying prices on the web. This example also involves asserting the data accuracy and timeliness with which the price information is displayed. The requirements for enabling the process capability changes are identified at a high-level and documented. For example the capability “Display Price” may require new or modified IT functions that 1) authenticate the customer's identity, 2) apply rules for determining the price for which the customer is entitled, 3) determine if price discounts are available, and 4) determine if promotional prices are available. The technical requirements resulting from this step should specify a) what function the IT systems and data must do, b) how well the function must be done, and c) under what conditions the function applies.

Block 426 determines if there are existing IT systems and data that are relevant to the initiative, and analyzes their fit and gaps with respect to the technical requirements identified in block 425. This step begins by assessing the portfolio of existing and in-development IT systems to determine those are relevant. The existing IT capabilities are evaluated against technical requirements to identify and quantify capability gaps. Similarly, existing information content and performance characteristics are evaluated against the technical requirements to identify and quantify gaps in coverage.

Block 427 defines the required high-level IT and data architectures to satisfy the technical requirements from block 425. For each technical capability gap identified in block 426, responsibility for its resolution is assigned to one or more existing or new IT systems and data repositories. In making this assignment, several factors should be considered, including: 1) the use of common components, 2) optimal placement of function within the technical landscape to meet integration and performance requirements, and 3) provisions for future extension and growth.

Block 427a evaluates the current application and data system portfolio with respect to the required high level IT and data architectures from block 427, and identifies opportunities to enhance or replace them. Factors that are considered in this assessment include the fit of the portfolio to the required architectures, gaps that remain, and alternatives for resolving the gaps.

Block 428 defines the high-level IT and data components necessary to complete the requirements from block 427. This step includes functional positioning, trade-off analysis of alternative approaches, and identification of new and changed IT and Data components, and confirmation that the selected design meets the IT and Data requirements. Block 428a establishes the high-level IT and data dependencies that are necessary to implement high-level IT and Data components identified in block 428. Among the dependency types to be considered are prerequisite and co-requisite systems, information sources and timing, and skills and training necessary for successful adoption.

Block 429 determines the expected costs and durations necessary to implement the IT and Data components established in block 428. These cost and duration estimates, along with the dependencies identified from block 428a are combined with the corresponding results of subprocess 205 (Evaluate Process Requirements) and subprocess 207 (Evaluate Organization and Management System Requirements) to influence the sequencing and staging of solution elements in subprocess 208 (Outline Solution Implementation and Deployment Approach).

Referring still to FIG. 4B, if organization and/or management system capability gaps were identified in block 414, then subprocess 207 evaluates the organization and management system requirements of the initiative through a sequence of steps 432-436. These steps result in a high-level organization and management system design, including dependencies, an assessment of the business' ability and willing to change, and estimated implementation costs. This process step focuses on evaluating the organization and management system changes required to enable a solution that delivers the desired process and strategic capabilities. Previous subprocesses 205 and 206 evaluated the process, information technology and data changes required to enable a solution. Further, subprocess 208 (described hereinafter) integrates the results of subprocesses 205, 206 and 207 into an outline of a total solution implementation and deployment approach.

Block 432 analyzes the organization and management system capabilities and capability gaps that were identified in block 414. The requirements for enabling the process capabilities are identified at a high level and documented. For example, the previously cited process capability “Display Prices” might decompose into an organizational requirement of skilled resources to design web interfaces and a management system requirement to systematically update web pricing.

Block 433 evaluates the current organization and management system against the requirements identified in block 432. This step identifies current organization and management system characteristics and systems that can be leveraged in the solution. It also identifies new characteristics or systems that must be established and changes that are required to current characteristics and systems. Block 434 uses the results of blocks 432 and 433 to design the required high-level organization and management system components of the solution. These components describe how the organization and management system will operate to enable the desired process capabilities.

Block 435 identifies the dependencies the organization and management system components have on other components external to the initiative. In this context, a dependency is defined as any organization or management system operation outside of the scope of the initiative that is required to enable processes within the initiative. For example, the skilled resources to design web interfaces requirement to “Display Price” may have a dependency on processes outside the initiative that provides training for web site design. Additionally, dependencies are identified between organization and management system operations within the scope of the initiative. For example, training must be completed or new hiring practices instituted before new skills can be utilized. The identified dependencies are documented in this step and used in subroutine 208 to formulate the solution dependencies.

Block 435a assesses the business' readiness and ability to make the changes identified in block 433 and defined in block 434. This step looks at the business' current state and identifies interventions, such as communications or education that may be required to ready the organization for the required changes. Bringing the business to a state where the changes can be embraced and implemented may impact the Solution Implementation and Deployment Approach defined in subprocess 208.

Block 436 estimates the costs to implement the organization and management system components of the solution. Exemplary costs include: 1) education and training, 2) communications and 3) management system development and 4) ongoing maintenance. The identified costs are documented in this step and used in a subsequent subroutine to formulate the solution business case.

Referring now to FIG. 4C, subroutine 208 (Outline Solution Implementation and Deployment Approach) outlines the implementation of the solution and how it will be deployed in a sequence of steps 439-445. These steps result in a solution approach with projects defined and a deployment timeline. Recalling from FIG. 4A, process capabilities were defined in block 411, and in block 414 gaps were identified between existing capabilities and the desired process capabilities. These capabilities gaps were characterized as: Process, Data, IT, Management System, and Organization (PDIMO). A single process capability gap can have one or more of these characteristics. Having “characteristics” means that each of those areas is to be considered when implementing the process capability. In the steps outlined in FIG. 4B, these capability gaps are analyzed to determine the Process, IT, Data, Organization and Management System components that are needed to close the gaps. The costs, benefits and dependencies are also identified. These results are used as input to subroutine 208.

In block 439 of FIG. 4C, the components from blocks 422, 428 and 434 of FIG. 4B are used to define alternative solution approaches. For example, alternatives could be to: 1) implement and deploy process, management system and/or organization components first and components that require IT and data changes at a later date; 2) implement components with high strategic and financial value first while deferring lesser value components; 3) implement components in a limited set of countries; 4) implement components for a limited area; 5) implement components for a limited product set; or 6) implement and deploy all components as a “big bang.” It will be noted that combinations of the above examples and other factors are also possible. Interdependencies between process, IT, data, management system and organization components that were identified in blocks 423, 428a and 435 are to be taken in to account when defining these alternatives.

In some alternatives, not all capability gaps will be closed at the same time. For a staged implementation, the sequence of deliverables for the solution is established. The scope of each deliverable is defined based on capability gaps, geographies, product sets and any other factors used to determine alternatives.

Strategic priorities established as input to the Initiative Definition assist in the analysis of alternatives, along with the implementation costs of specific capabilities defined in blocks 423a, 429 and 436 and benefits defined in block 415. The known constraints identified in block 404 and confirmed with stakeholders in block 407 also need to be considered. When analyzing the component elements to close the gaps, it may be possible to “buy” the needed component or “make it” with internal development. This decision is most obvious in the case of IT, but could also be relevant in “outsourcing” certain process capabilities or certain people related tasks associated with the organization or management system. These alternatives are also analyzed in block 439 of FIG. 4C.

In block 441, an initial identification of assumptions, dependencies and risks is made for each alternative solution that was defined in block 439. Then, in block 440, an alternative is selected based on the strategic priorities, the implementation costs, the projected benefits and the identified risks.

In block 442, the deployment expectations for the proposed solution are defined. A timeline is created for the proposed solution. For solutions that have a staged set of deliverables defined, the sequence of those deliverables is used to create the timeline. Each deliverable is documented regarding its defined scope for business areas and geographic areas covered.

In block 443, the deliverables of the proposed solution from block 440 are assigned to one or more projects for development. When determining the definition of the projects, the capability gaps and their characteristic (PDIMO) and dependencies are considered. In the case of information technology, the applications affected are also considered.

In block 443a, the dependencies and risks developed in block 441 are further refined for the proposed solution including any additional dependencies, risks or assumptions specific to the deployment expectations or solution development projects. In the extreme case, this may call for reexamination of the alternative selected to reduce the dependencies and risks to an acceptable level.

In block 444, the proposed solution is reviewed with the stakeholders. It may also be necessary to expand on the list of stakeholders that was developed in block 407 (FIG. 4A). For example, information technology application owners that were not known in block 407 will now become stakeholders. Their agreement with the solution and its dependencies on their applications needs to be obtained. There may be similar new stakeholders with regards to data, process, organization and management system.

In decision block 445, if agreement with the proposed solution is reached, then in decision block 446 agreement to proceed is sought. If the solution is not agreed to, then feedback is used to reassess the alternatives by returning to block 439. If after agreeing with the solution the executives also agree to proceed, then the method moves on to development of the business case and Key Results Metrics in subroutine 447. On the other hand, if there is not agreement to proceed, the unsatisfied strategic capabilities are returned to the Strategic Planning Process 101 in FIG. 4A.

As further shown in FIG. 4C, the Develop Business Case & Key Results Metrics subroutine 209 evaluates the process requirements of the initiative through a sequence of steps 448-454a. These steps result in a high level cost and benefit analysis and key results metrics. This process step focuses on evaluating the cost to implement the solution and the short term and long term benefits of enabling the desired process capabilities over a specific time horizon. All of the information learned from the other Initiative Definition activities is preferably the basis for developing the business case. Subroutine 209 integrates the results of blocks 429, 436 and 439 into cost and benefit view. The business case developed in subroutine 209 will identify the reason for whether or not to proceed with solution development.

Block 448 identifies the planning assumptions that will form the basis of the business case. For example, if the business case is claiming a percentage increase in revenue, then the base revenue amount must be a published and agreed upon dollar figure. If headcount reductions are anticipated, then the cost of a full time employee must be a published known dollar amount. In addition, stakeholders benefiting from the desired process capabilities must agree with the business case planning assumptions.

Block 449 refines the solution costs over the business case time horizon. In most cases, a high percentage of solution cost occurs at the front end of the project and is related to development and test. These costs are contained in the business case during the time frame that development and test will be occurring, for example, during the current year or first year of the project. In many cases, solutions are deployed in phases therefore some cost can be spread over the time it takes to deploy the full scope of the solution. For example, the solution may be world wide in scope and deployment will occur sequentially by geography. In that case, the costs for IT enablement may be spread across the amount of time needed for deployment in each geography. Another example is deployment by sales channel. In order to minimize organizational impact, a solution may be deployed sequentially by sales channel (e.g., telesales, face-to-face, and distributors). The cost would then be incurred as the solution deploys in each channel. In addition to sequential deployments, there may be long term costs that will diminish over time. For instance, education and training associated with solution deployment may be required over several months and will gradually reduce as users are able to provide self education.

Block 450 refines the expected benefits over the business case time horizon. Solution benefits are generally not a one time occurrence, but rather will be realized and measured over months and/or years. The business case should reflect the time horizon when a business will fully realize benefits of solution deployment. A solution that claims additional revenue as a benefit can claim the revenue benefits in successive years that have been agreed to by the stakeholders. For instance, if a solution enables Demand Conditioning processes and techniques that will generate incremental revenue above and beyond the forecast, the incremental amount may be prorated at a diminishing rate for X years that the demand conditioning process and technique are effective. Another example is cost savings; if a solution will eliminate costs from a process, then the business case should reflect the cost reductions as each phase of the project deploys and cost savings are projected to be realized. For instance, if a solution will reduce headcount, the projected savings may be aligned with sequential deployments.

Block 451 identifies metrics for measuring business performance and transformation results. It is desirable to ensure that metrics are established up front that will measure the effectiveness of the process changes on a regular basis. Benefits claimed in block 450 should be measurable and attributable solely to the capabilities enabled by the solution. Intangible benefits, such as productivity improvements, should be documented and can add richness to the business case, but a metrics dashboard that that can measure specific benefits and cause is desirable. For instance, if the solution claims additional revenue as a benefit, a measurement should be in place to capture the incremental revenue and point to the source of improvement. A Demand Conditioning solution, for example, may claim additional revenue by steering customers to a more enhanced or higher priced product. A tactic code might be assigned to the enhanced product so that each sale is recorded and therefore measurable. A strong metrics dashboard capable of measuring benefits and transformation results is instrumental in obtaining Stakeholder buy in.

In order to develop the measurements and metrics for demonstrating the improvements it is important to have a good understanding of the metrics that are in place to the existing process. In some cases, these metrics will be sufficient to demonstrate improvement. In other cases, the existing metrics will have to be adjusted or new metrics developed.

Block 452 assembles the business case. In this step, all of the information gathered in blocks 448, 449, 450 and 451 are consolidated into a format that will lay out the business case planning assumptions, costs, benefits and the metrics system that will be used to measure transformation progress and benefit realization.

Block 453 will interlock the business case with solution stakeholders. In this step, the stakeholders review the business case assumptions and claims and make a decision whether to proceed with the project and move to solution development. The information presented to the stakeholders in this step should be familiar to them. Estimated costs and benefits have been collected in blocks 429, 436 and 439. In addition, solution alternatives were examined in block 439. All of this information, plus risks, solution expectations and timeline were presented to stakeholders in block 444. The business case formalizes the information so that stakeholders have a clear understanding of the costs and benefits, and can make an educated decision whether to proceed with the project as proposed or to cancel the project before investing in solution development.

In decision block 454, if agreement with the business case is reached, then in decision block 454a agreement to proceed is sought. If the business case is not agreed to, then feedback is used to reassess the planning assumptions by returning to block 448. If after agreeing with the business case the executives also agree to proceed, then the method moves on to the Gain Approval to Proceed to Solution Development in subroutine 210. On the other hand, if there is not agreement to proceed, the unsatisfied strategic capabilities are returned to the Strategic Planning Process 101 in FIG. 4A.

Finally, FIG. 4C illustrates subroutine 210 (Gain Approval to Proceed to Solution Development), which describes the process requirements for obtaining approval to proceed to solution development through a sequence of steps 456-461. These steps, when executed, result in any necessary management approvals to go forward. It will be noted, however, that for smaller organizational entities, a formal approval process may not be needed and the Solution Development Process 103 may be implemented at this point.

In any case, block 456 conducts sponsor and portfolio management reviews. This is a final review with the project sponsor and portfolio management team prior to seeking approval to proceed. A template is preferably created to summarize pertinent information about the initiative so that the approval body can ascertain the scope, cost and benefit. This should cover process, data, information technology, management system and organizational aspects of the initiative. The following information may be included in the template: Process and Capabilities supported, Investments, and Benefits (revenue and/or savings). The supporting documentation should also demonstrate how the investment in the closure of the process capability gaps supports the Strategic Capabilities and Strategic Priorities define as input from the Strategic Planning process. The Sponsor and Portfolio Management team will review the template for completeness and clarity.

In block 457, the template and business case is presented to the Approval Body with a request to proceed to the development phase. The Approval Body will make their decision based on the process and capabilities that will be supported by the initiative and the merits of the business case. Block 458 represents the GO/NO GO Decision of the Approval Body. Block 459 is an agreement to proceed to solution development. The template created in block 456 will be passed to the solution development team and can serve as the project charter for the next phase.

Block 103 (as indicated previously) is the Solution Development phase. In aggregate, the Initiative Definition Process provides a complete and holistic view of transformation requirements, impacts, prioritized investment opportunities, cost/benefit information, and solutions defined to deliver against expectations, all with a consistent approach to solution identification and business case development outputs to the Solution Development Process block 103, which further defines specific projects, deployment expectations and key dependencies for solution development and refines business case and key results metrics. In this process, specific projects are defined and deployed to enable the strategic capabilities and fill capability gaps identified during the Initiative Definition Process.

Block 461 represents No Agreement to proceed. If the Approval Body determines that the initiative does not warrant further investment and development, the initiative will return to decision block 446 and interlock with Stakeholders. The Stakeholders will determine if the initiative scope and/or business case can be reworked and returned to the Approval Body for agreement to proceed. If the Stakeholders and project team elect to proceed, the initiative team will return to block 447 to rework the Business Case.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above and illustrated in FIGS. 2-4.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for translating a defined business strategy into solution development initiatives, the method comprising:
receiving strategic input information from a strategic planning process, said strategic input information including parameters related to the defined business strategy;
refining business and processes requirements in accordance with said strategic input information so as to determine one or more of: process capability gaps, information technology (IT) and data gaps, and organization and management system gaps;
evaluating one or more of: process requirements, IT and data requirements, and organization and management system requirements so as to identify one or more of: process changes, IT and data changes, and organization and management system changes to be implemented so as to enable corresponding solutions for delivering desired capabilities therein;
outlining a solution implementation and deployment approach, based on said identified changes; and
developing a business case and key results metrics from said outlined solution implementation and deployment approach, and implementing solution development initiatives in accordance therewith.

2. The method of claim 1, further comprising determining the feasibility of implementing the defined business strategy, based on said strategic input information and reaching an agreement to proceed prior to said refining business and processes requirements.

3. The method of claim 2, wherein said determining the feasibility further comprises one or more of:
identifying known constraints related to the success of the solution development initiatives;
analyzing said strategic input information and priorities thereof, expected value and scope with respect to said known constraints;
identifying feasible options compatible with said known constraints, while delivering the expected value of the strategic capabilities;
receiving input from stakeholders associated with the solution development initiatives with respect to said identified feasible options; and
reaching said agreement to proceed in the event said known constraints are compatible with an expected value of the solution development initiatives.

4. The method of claim 3, wherein, in the event said known constraints are not compatible with said expected value of the solution development initiatives, implementing one of:
redefining the feasible options; and
terminating initiative definition and providing feedback to said strategic planning process for reexamination of the defined business strategy.

5. The method of claim 1, wherein said refining business and processes requirements in accordance with said strategic input information further comprises one or more of:
translating strategic capabilities included in said strategic input information into process capabilities;
defining scenarios that incorporate said process capabilities;
determining and evaluating requirements unique to a specific business unit; and
defining feasible options compatible with any determined business unit requirement conflicts;
receiving input from stakeholders associated with the solution development initiatives with respect to said identified feasible options; and
reaching an agreement to proceed in the event said requirement conflicts are compatible with an expected value of the solution development initiatives.

6. The method of claim 5, wherein, in the event said known constraints are not compatible with said expected value of the solution development initiatives, implementing one of:
redefining the feasible options; and
terminating initiative definition and providing feedback to said strategic planning process for reexamination of the defined business strategy.

7. The method of claim 1, wherein said evaluating process requirements further comprises one or more of:
analyzing said process capability gaps and documenting high-level requirements for implementing said identified process changes;
determining the existence of any business processes and rules that are relevant to the initiative and identifying any conflicts between said requirements for implementing said identified process changes and said business processes and rules, wherein any identified conflicts therebetween are mitigated by one or more of: modifying said requirements and determining whether said business processes and rules may be modified without impact to other processes;
identifying process capabilities that require business rules to operate;
designing high-level process components for enabling the desired process capabilities;
identifying any dependencies said process components have on other processes external to the solution development initiatives; and
estimating costs associated with implementing said process components.

8. The method of claim 1, wherein said evaluating IT and data requirements further comprises one or more of:
analyzing said information technology (IT) and data gaps and documenting high-level requirements for implementing said identified IT and data changes;
determining the existence of any IT systems and data that are relevant to the initiative and evaluating existing IT capabilities with respect to technical requirements for identifying and quantifying capability gaps;
evaluating existing information content and performance characteristics are evaluated with respect to said technical requirements for identifying and quantifying capability gaps;
defining a high-level IT and data architecture for implementing documented high-level requirements and assigning each quantified technical capability gap to one or more existing and new IT systems and data repositories;
evaluating a current application and data system portfolio with respect to said defined high-level IT and data architecture, and identifying opportunities to enhance or replace the same;
defining high-level IT and data components associated with said high-level IT and data architecture, and determining any high-level IT and data dependencies associated with implementing said high-level IT and data components; and
estimating costs associated with implementing said high-level IT and data components.

9. The method of claim 1, wherein said evaluating organization and management system requirements further comprises one or more of:
analyzing said organization and management system capability gaps and documenting high-level requirements for implementing said identified organization and management system changes;
determining the existence of any IT systems and data that are relevant to the initiative and evaluating existing IT capabilities with respect to technical requirements for identifying and quantifying capability gaps;
evaluating a current organization and management system with respect to said high-level requirements for implementing said identified organization and management system changes;
identifying current organization and management system characteristics and systems that are useable for implementing said identified organization and management system changes;
identifying new characteristics and systems for implementing said identified organization and management system changes;
identifying changes to current organization and management system characteristics for implementing said identified organization and management system changes;
defining high-level organization and management system components for implementing documented high-level requirements for implementing said identified organization and management system changes;
identifying any dependencies said organization and management system components have on other components external to the solution development initiatives;
assessing readiness and ability to make changes associated with implementing said high-level organization and management system components; and
estimating costs associated with implementing said high-level organization and management system components.

10. The method of claim 1, wherein said outlining a solution implementation and deployment approach further comprises:
identifying and analyzing alternative solution approaches to any process, IT, data, organization and management system components to be implemented in close identified gaps therein;
identifying any assumptions, dependencies and risks associated with each identified alternative solution approaches;
selecting a proposed solution based on said strategic priorities, implementation costs associated therewith, projected benefits associated therewith and identified risks associated therewith;
defining deployment expectations for said proposed solution, including one or more of: a timeline, a set of defined deliverables and covered geographic areas;
assigning said defined deliverables to one or more projects for development;
refining assumptions, dependencies and risks with respect to said proposed solution, including any additional dependencies, risks or assumptions specific to said deployment expectations and said projects for development;
reviewing said proposed solution with stakeholders associated therewith and reaching an agreement as to said proposed solution, and alternatively repeating said identifying and analyzing alternative solution approaches in the event said proposed solution is not agreed to; and
reaching an agreement to proceed with said proposed solution.

11. The method of claim 1, wherein said developing a business case and key results metrics further comprises one or more of:
identifying planning assumptions forming the basis of the business case;
refining proposed solution costs over a business case time horizon;
refining proposed solution expected benefits over said business case time horizon;
identifying metrics for measuring business performance and transformation results;
assembling the business case using said planning assumptions, costs, expected benefits and metrics to measure transformation progress and benefit realization;
reviewing said business case with stakeholders associated therewith and reaching an agreement as to assumptions of said business case, and alternatively reassessing said planning assumptions in the event said business case is not agreed to; and
reaching an agreement to proceed with said solution development initiatives.

12. The method of claim 1, further comprising gaining approval to proceed with solution development following said developing a business case and key results metrics, wherein said approval further comprises:
conducting sponsor and portfolio management reviews;
creating a template summarizing process, data, information technology, management system and organizational aspects of the proposed solution initiatives;
presenting a request to proceed to an approval body, along with said business case and said template.

13. A system for translating a defined business strategy into solution development initiatives, comprising:
a host server executing an information engine, said host server connected to a network accessible by one or more client applications;
said information engine configured to implement a method further comprising receiving, through said one or more client applications, strategic input information from a strategic planning process, said strategic input information including parameters related to the defined business strategy;
refining business and processes requirements in accordance with said strategic input information so as to determine one or more of: process capability gaps, information technology (IT) and data gaps, and organization and management system gaps;
evaluating one or more of: process requirements, IT and data requirements, and organization and management system requirements so as to identify one or more of: process changes, IT and data changes, and organization and management system changes to be implemented so as to enable corresponding solutions for delivering desired capabilities therein;
outlining a solution implementation and deployment approach, based on said identified changes; and
developing a business case and key results metrics from said outlined solution implementation and deployment approach, and implementing solution development initiatives in accordance therewith.

14. The system of claim 13, wherein said method implemented by said information engine further comprises determining the feasibility of implementing the defined business strategy, based on said strategic input information and reaching an agreement to proceed prior to said refining business and processes requirements, said determining the feasibility further comprising one or more of:
identifying known constraints related to the success of the solution development initiatives;
analyzing said strategic input information and priorities thereof, expected value and scope with respect to said known constraints;
identifying feasible options compatible with said known constraints, while delivering the expected value of the strategic capabilities;
receiving input from stakeholders associated with the solution development initiatives with respect to said identified feasible options; and
reaching said agreement to proceed in the event said known constraints are compatible with an expected value of the solution development initiatives.

15. The system of claim 13, wherein said refining business and processes requirements in accordance with said strategic input information further comprises one or more of:
translating strategic capabilities included in said strategic input information into process capabilities;
defining scenarios that incorporate said process capabilities;
determining and evaluating requirements unique to a specific business unit; and
defining feasible options compatible with any determined business unit requirement conflicts;
receiving input from stakeholders associated with the solution development initiatives with respect to said identified feasible options; and
reaching an agreement to proceed in the event said requirement conflicts are compatible with an expected value of the solution development initiatives.

16. The system of claim 13, wherein said evaluating process requirements further comprises one or more of:
analyzing said process capability gaps and documenting high-level requirements for implementing said identified process changes;
determining the existence of any business processes and rules that are relevant to the initiative and identifying any conflicts between said requirements for implementing said identified process changes and said business processes and rules, wherein any identified conflicts therebetween are mitigated by one or more of: modifying said requirements and determining whether said business processes and rules may be modified without impact to other processes;
identifying process capabilities that require business rules to operate;
designing high-level process components for enabling the desired process capabilities;
identifying any dependencies said process components have on other processes external to the solution development initiatives; and
estimating costs associated with implementing said process components.

17. The system of claim 13, wherein said evaluating IT and data requirements further comprises one or more of:
analyzing said information technology (IT) and data gaps and documenting high-level requirements for implementing said identified IT and data changes;
determining the existence of any IT systems and data that are relevant to the initiative and evaluating existing IT capabilities with respect to technical requirements for identifying and quantifying capability gaps;
evaluating existing information content and performance characteristics are evaluated with respect to said technical requirements for identifying and quantifying capability gaps;
defining a high-level IT and data architecture for implementing documented high-level requirements and assigning each quantified technical capability gap to one or more existing and new IT systems and data repositories;
evaluating a current application and data system portfolio with respect to said defined high-level IT and data architecture, and identifying opportunities to enhance or replace the same;
defining high-level IT and data components associated with said high-level IT and data architecture, and determining any high-level IT and data dependencies associated with implementing said high-level IT and data components; and
estimating costs associated with implementing said high-level IT and data components.

18. The system of claim 13, wherein said evaluating organization and management system requirements further comprises one or more of:
analyzing said organization and management system capability gaps and documenting high-level requirements for implementing said identified organization and management system changes;
determining the existence of any IT systems and data that are relevant to the initiative and evaluating existing IT capabilities with respect to technical requirements for identifying and quantifying capability gaps;
evaluating a current organization and management system with respect to said high-level requirements for implementing said identified organization and management system changes;
identifying current organization and management system characteristics and systems that are useable for implementing said identified organization and management system changes;
identifying new characteristics and systems for implementing said identified organization and management system changes;
identifying changes to current organization and management system characteristics for implementing said identified organization and management system changes;
defining high-level organization and management system components for implementing documented high-level requirements for implementing said identified organization and management system changes;
identifying any dependencies said organization and management system components have on other components external to the solution development initiatives;
assessing readiness and ability to make changes associated with implementing said high-level organization and management system components; and
estimating costs associated with implementing said high-level organization and management system components.

19. The system of claim 13, wherein said outlining a solution implementation and deployment approach further comprises:
identifying and analyzing alternative solution approaches to any process, IT, data, organization and management system components to be implemented in close identified gaps therein;
identifying any assumptions, dependencies and risks associated with each identified alternative solution approaches;
selecting a proposed solution based on said strategic priorities, implementation costs associated therewith, projected benefits associated therewith and identified risks associated therewith;
defining deployment expectations for said proposed solution, including one or more of: a timeline, a set of defined deliverables and covered geographic areas;
assigning said defined deliverables to one or more projects for development;
refining assumptions, dependencies and risks with respect to said proposed solution, including any additional dependencies, risks or assumptions specific to said deployment expectations and said projects for development;
reviewing said proposed solution with stakeholders associated therewith and reaching an agreement as to said proposed solution, and alternatively repeating said identifying and analyzing alternative solution approaches in the event said proposed solution is not agreed to; and
reaching an agreement to proceed with said proposed solution.

20. The system of claim 13, wherein said developing a business case and key results metrics further comprises one or more of:
identifying planning assumptions forming the basis of the business case;
refining proposed solution costs over a business case time horizon;
refining proposed solution expected benefits over said business case time horizon;
identifying metrics for measuring business performance and transformation results;
assembling the business case using said planning assumptions, costs, expected benefits and metrics to measure transformation progress and benefit realization;
reviewing said business case with stakeholders associated therewith and reaching an agreement as to assumptions of said business case, and alternatively reassessing said planning assumptions in the event said business case is not agreed to; and
reaching an agreement to proceed with said solution development initiatives.

21. A storage medium, comprising:
a machine readable computer program code for translating a defined business strategy into solution development initiatives; and
instructions for causing a computer to implement a method, the method further comprising:
receiving strategic input information from a strategic planning process, said strategic input information including parameters related to the defined business strategy;
refining business and processes requirements in accordance with said strategic input information so as to determine one or more of: process capability gaps, information technology (IT) and data gaps, and organization and management system gaps;
evaluating one or more of: process requirements, IT and data requirements, and organization and management system requirements so as to identify one or more of: process changes, IT and data changes, and organization and management system changes to be implemented so as to enable corresponding solutions for delivering desired capabilities therein;
outlining a solution implementation and deployment approach, based on said identified changes; and
developing a business case and key results metrics from said outlined solution implementation and deployment approach, and implementing solution development initiatives in accordance therewith.

22. The storage medium of claim 21, further comprising determining the feasibility of implementing the defined business strategy, based on said strategic input information and reaching an agreement to proceed prior to said refining business and processes requirements.

23. The method of claim 22, wherein said determining the feasibility further comprises one or more of:
identifying known constraints related to the success of the solution development initiatives;
analyzing said strategic input information and priorities thereof, expected value and scope with respect to said known constraints;
identifying feasible options compatible with said known constraints, while delivering the expected value of the strategic capabilities;
receiving input from stakeholders associated with the solution development initiatives with respect to said identified feasible options; and
reaching said agreement to proceed in the event said known constraints are compatible with an expected value of the solution development initiatives.

24. The storage medium of claim 21, wherein said refining business and processes requirements in accordance with said strategic input information further comprises one or more of:
translating strategic capabilities included in said strategic input information into process capabilities;
defining scenarios that incorporate said process capabilities;
determining and evaluating requirements unique to a specific business unit; and
defining feasible options compatible with any determined business unit requirement conflicts;
receiving input from stakeholders associated with the solution development initiatives with respect to said identified feasible options; and
reaching an agreement to proceed in the event said requirement conflicts are compatible with an expected value of the solution development initiatives.

25. The storage medium of claim 21, wherein said evaluating process requirements further comprises one or more of:
analyzing said process capability gaps and documenting high-level requirements for implementing said identified process changes;
determining the existence of any business processes and rules that are relevant to the initiative and identifying any conflicts between said requirements for implementing said identified process changes and said business processes and rules, wherein any identified conflicts therebetween are mitigated by one or more of: modifying said requirements and determining whether said business processes and rules may be modified without impact to other processes;
identifying process capabilities that require business rules to operate;
designing high-level process components for enabling the desired process capabilities;
identifying any dependencies said process components have on other processes external to the solution development initiatives; and
estimating costs associated with implementing said process components.

26. The storage medium of claim 21, wherein said evaluating IT and data requirements further comprises one or more of:
analyzing said information technology (IT) and data gaps and documenting high-level requirements for implementing said identified IT and data changes;
determining the existence of any IT systems and data that are relevant to the initiative and evaluating existing IT capabilities with respect to technical requirements for identifying and quantifying capability gaps;
evaluating existing information content and performance characteristics are evaluated with respect to said technical requirements for identifying and quantifying capability gaps;
defining a high-level IT and data architecture for implementing documented high-level requirements and assigning each quantified technical capability gap to one or more existing and new IT systems and data repositories;
evaluating a current application and data system portfolio with respect to said defined high-level IT and data architecture, and identifying opportunities to enhance or replace the same;
defining high-level IT and data components associated with said high-level IT and data architecture, and determining any high-level IT and data dependencies associated with implementing said high-level IT and data components; and
estimating costs associated with implementing said high-level IT and data components.

27. The storage medium of claim 21, wherein said evaluating organization and management system requirements further comprises one or more of:
analyzing said organization and management system capability gaps and documenting high-level requirements for implementing said identified organization and management system changes;
determining the existence of any IT systems and data that are relevant to the initiative and evaluating existing IT capabilities with respect to technical requirements for identifying and quantifying capability gaps;
evaluating a current organization and management system with respect to said high-level requirements for implementing said identified organization and management system changes;
identifying current organization and management system characteristics and systems that are useable for implementing said identified organization and management system changes;
identifying new characteristics and systems for implementing said identified organization and management system changes;
identifying changes to current organization and management system characteristics for implementing said identified organization and management system changes;
defining high-level organization and management system components for implementing documented high-level requirements for implementing said identified organization and management system changes;
identifying any dependencies said organization and management system components have on other components external to the solution development initiatives;
assessing readiness and ability to make changes associated with implementing said high-level organization and management system components; and
estimating costs associated with implementing said high-level organization and management system components.

28. The storage medium of claim 21, wherein said outlining a solution implementation and deployment approach further comprises:
identifying and analyzing alternative solution approaches to any process, IT, data, organization and management system components to be implemented in close identified gaps therein;
identifying any assumptions, dependencies and risks associated with each identified alternative solution approaches;
selecting a proposed solution based on said strategic priorities, implementation costs associated therewith, projected benefits associated therewith and identified risks associated therewith;
defining deployment expectations for said proposed solution, including one or more of: a timeline, a set of defined deliverables and covered geographic areas;
assigning said defined deliverables to one or more projects for development;
refining assumptions, dependencies and risks with respect to said proposed solution, including any additional dependencies, risks or assumptions specific to said deployment expectations and said projects for development;
reviewing said proposed solution with stakeholders associated therewith and reaching an agreement as to said proposed solution, and alternatively repeating said identifying and analyzing alternative solution approaches in the event said proposed solution is not agreed to; and
reaching an agreement to proceed with said proposed solution.

29. The storage medium of claim 21, wherein said developing a business case and key results metrics further comprises one or more of:
identifying planning assumptions forming the basis of the business case;
refining proposed solution costs over a business case time horizon;
refining proposed solution expected benefits over said business case time horizon;
identifying metrics for measuring business performance and transformation results;
assembling the business case using said planning assumptions, costs, expected benefits and metrics to measure transformation progress and benefit realization;
reviewing said business case with stakeholders associated therewith and reaching an agreement as to assumptions of said business case, and alternatively reassessing said planning assumptions in the event said business case is not agreed to; and
reaching an agreement to proceed with said solution development initiatives.

30. The storage medium of claim 21, further comprising gaining approval to proceed with solution development following said developing a business case and key results metrics, wherein said approval further comprises:
conducting sponsor and portfolio management reviews;
creating a template summarizing process, data, information technology, management system and organizational aspects of the proposed solution initiatives;
presenting a request to proceed to an approval body, along with said business case and said template.
